(19) United States
(12) Patent Application Publication
(10) Pub. No.: US 2022/0098366 A1
(43) Pub. Date: Mar. 31, 2022

(54) METHOD OF GRINDING POLY(ETHER KETONE KETONE) (PEKK)

(71) Applicant: SOLVAY SPECIALTY POLYMERS USA, LLC, Alpharetta, GA (US)

(72) Inventors: Scott A. HARDING, Alpharetta, GA (US); William W. LOONEY, Sugar Hill, GA (US)

(21) Appl. No.: 17/426,671

(22) PCT Filed: Jan. 24, 2020
(86) PCT No.: PCT/EP2020/051768

§ 371 Date: Jul. 29, 2021

Related U.S. Application Data
(60) Provisional application No. 62/799,112, filed on Jan. 31, 2019.

(30) Foreign Application Priority Data
Mar. 13, 2019 (EP) 19162687.8

(51) Int. Cl. C08G 65/46; C08G 65/40; B29C 64/153; B33Y 70/00; B33Y 10/00

(52) U.S. Cl. CPC C08G 65/46; C08G 65/4012; C09D 171/10; B33Y 70/00; B33Y 10/00; B29C 64/153

(57) ABSTRACT

The present disclosure relates to process of obtaining a powder of poly(ether ketone ketone) (PEKK) polymer, comprising grinding a PEKK polymer at a temperature comprised between 60° C. and 85° C., wherein the powder has a d₅₀-value comprised 0 between 40 pm and 60 pm (as measured by laser scattering in isopropanol). The present invention also relates to a PEKK powder presenting such particle size distribution (PSD), obtained by the grinding method of the present invention.

### RELATED APPLICATIONS

This application claims priority to U.S. provisional application U.S. 62/799,112 filed on Jan. 31, 2019 and to European patent application EP 19162687.8. filed on Mar. 13, 2019, the whole content of these applications being incorporated herein by reference for all purposes.

### TECHNICAL FIELD

The present disclosure relates to process of obtaining a powder of poly(ether ketone ketone) (PEKK) polymer, comprising grinding a PEKK polymer at a temperature comprised between 60° C. and 85° C., wherein the powder has a d₅₀-value comprised between 40 μm and 60 μm (as measured by laser scattering in isopropanol). The present invention also relates to a PEKK powder presenting such particle size distribution (PSD), obtained by the grinding method of the present invention, as well as to the use of such powder for the manufacture of three-dimensional (3D) objects using a laser-sintering based additive manufacturing (AM) system, or in a coating composition.

### BACKGROUND ART

Method of obtaining polymer powder presenting a certain PSD by grinding are described in the literature. It is generally recommended to carry out these methods at low temperature.

US 2009/0280263 (Degussa) describes a method for grinding poly(aryl ether ketones) (PAEK) starting from PAEK having an apparent specific surface area measured by BET above 1 m²/g. According to this document, it is advantageous to mill the porous PAEK at a temperature below 0° C., preferably below −20° C., even more preferably below −40° C. In the examples, PEEK granules having a BET surface area of 50 m²/g are milled with a cryogenically operating pinned-disk mill.

U.S. Pat. No. 5,247,052 (Hoechst) describes a method of grinding of PAEK with a fluid-bed opposed-jets mill in which the circulating coarse material is cooled by a cryogenic refrigerant (nitrogen or carbon dioxide).

US 2005/0207931 (Toyota) notably describes a methods for producing a powder, including cooling the coarse granulate comprising the plastic matrix material to form brittle, coarse granulates and grinding these granulates, preferably carried out with cooling.

CA 2,086,780 (Bayer) describes a process for size reduction of organic polymers between cylindrical or conical rollers which rotate in the same direction or in opposite directions with a specific speed ratio or a predetermined shear rate ratio in the roller gap. The rollers are preferably cooled to dissipate the heat generated during the grinding process and have preferably an operating temperature in the range from 0 to 30° C.

US 2014/0322441 (Arkema) relates to a method of grinding PAEK which can be carried at ambient temperature, typically at a temperature between 0 and 50° C. In the examples, PEKK is micronized in an impact grinder-selector at a temperature of 25° C.

PEKK polymers are usually prepared by a ketone-forming reaction, in the presence of a Lewis acid, at a temperature ranging from 0 to 120° C. The PEKK polymer produced from this process however presents a major drawback in that it contains a high volatiles (e.g. chlorinated residual solvent) content. This is undesirable for a certain number of applications, for example for the manufacture of 3D objects using a laser-sintering based additive manufacturing system. The problem of the high volatile residual contents could be solved by the addition of post-treatment steps, but this adds to the cost of overall production of the polymer.

The grinding methods of the prior art have been assessed to grind a PEKK polymer prepared according to the nucleophilic synthesis route described in WO 2018/115033 (Solvay), but have been unsuccessful in order to obtain a powder with a d₅₀-value comprised between 40 μm and 60 μm.

### SUMMARY OF INVENTION

An aspect of the present disclosure is directed to process of obtaining a powder of poly(ether ketone ketone) (PEKK) polymer, comprising grinding a PEKK polymer at a temperature comprised between 60° C. and 85° C., wherein the powder has a d₅₀-value comprised between 40 and 60 μm. Preferably, the powder of PEKK has after the step of grinding:
a BET surface area ranging from 0.1 to 5 m²/g, as measured by ISO 9277, at a soak temperature of 25° C.,
a bulk density ρB of at least 0.39, and/or
an aspect ratio AR of less than 1.5, wherein the aspect ratio is the average ratio of maximum length dimension to minimum length, as counted on about 100 particles from a scanning electron microscopy (SEM) image.

The step of grinding may for example take place in a disc mill in which rotating discs crush the PEKK polymer by attrition forces.

Another aspect of the present disclosure is directed to the PEKK powder obtainable by the process of invention, to a PEKK powder having a d₅₀-value comprised between 40 μm and 60 μm, as measured by laser scattering in isopropanol, and an aspect ratio AR of less than 1.5, wherein the aspect ratio is the average ratio of maximum length dimension to minimum length, as counted on about 60 particles from a scanning electron microscopy (SEM) image. The PEKK powder preferably has:
a BET surface area ranging from 0.1 to 5 m²/g, as measured by ISO 9277, at a soak temperature of 25° C., and/or
a bulk density ρB of at least 0.39.

Another aspect of the present disclosure is directed to the polymeric powder comprising:
the PEKK powder of the invention,
at least one flow agent (F), and/or
at least one additive (A) selected from the group consisting of fillers, colorants, dyes, pigments, lubricants, plasticizers, flame retardants, nucleating agents, heat stabilizers, light stabilizers, antioxidants, processing aids, fusing agents and electromagnetic absorbers.

The present invention also relates to the use of this PEKK powder or of the polymeric powder, for the manufacture of three-dimensional objects using a laser-sintering based additive manufacturing system, as well as to a coating composition comprising this PEKK powder.

### DESCRIPTION OF EMBODIMENTS

The present invention relates to a process of obtaining a powder of poly(ether ketone ketone) (PEKK) polymer, comprising grinding a PEKK polymer at a temperature comprised between 60° C. and 85° C., wherein the powder has a d₅₀-value comprised between 40 μm and 60 μm, as measured by laser scattering in isopropanol.

Preferably, the PEKK powder obtained from this process also has a d₁₀-value higher than 25 μm and/or a d₉₀-value of less than 120 μm (as measured by laser scattering in isopropanol).

The present invention also relates to a PEKK powder presenting such particle size distribution (PSD), obtained by the grinding method of the present invention, as well as to the use of such powder for the manufacture of 3D objects using a laser-sintering based AM system, or in a coating composition.

In the present application:
any description, even though described in relation to a specific embodiment, is applicable to and interchangeable with other embodiments of the present invention;
where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list; and
any recitation herein of numerical ranges by endpoints includes all numbers subsumed within the recited ranges as well as the endpoints of the range and equivalents.

Process of Obtaining the PEKK Powder

An object of the present invention relates to a process of obtaining a powder of poly(ether ketone ketone) (PEKK) polymer, comprising grinding a PEKK polymer at a temperature comprised between 60° C. and 85° C. inclusive, preferably between 70° C. and 80° C. inclusive, wherein the powder has a d₅₀-value comprised between 40 μm and 60 μm (as measured by laser scattering in isopropanol), and preferably also a d₁₀-value higher than 25 μm and/or a d₉₀-value of less than 120 μm.

The grinding mills can be of any type, as long as the temperature of the grinding step can be adjusted to a temperature range varying between 60° C. and 85° C. inclusive, preferably between 65° C. and 82° C. inclusive or even between 70° C. and 80° C. inclusive.

According to an embodiment, the PEKK polymer to be ground or milled is in the form of a so-called “coarse PEKK powder”, for example a PEKK powder having a d₉₀-value between 500 μm and 4,000 μm, preferably between 600 μm and 2,000 μm, and/or a d₅₀-value between 200 and 2,000 μm, preferably between 300 and 1,000 μm. Such a coarse PEKK powder can be obtained by a polycondensation reaction and an additional step of extracting the solvent and salts after polycondensation, as well as optional post-treatment step(s) (such as tempering or heat treatment) of the PEKK polymer obtained from the polycondensation/extraction. According to this embodiment, the coarse PEKK powder is ground to produce the PEKK powder of the present invention, having a d₅₀-value comprised between 40 μm and 60 μm (as measured by laser scattering in isopropanol), and preferably also a d₁₀-value higher than 25 μm and/or a d₉₀-value of less than 120 μm.

The powder particles of the PEKK powder preferably have a spherical form or an approximately spherical form. This means that the powder particles of the PEKK powder preferably have an aspect ratio of less than 2.0. Such aspect ratio of the powder particles is more preferably of less than 1.5, and most preferably of less than 1.48. The term aspect ratio used herein means the average ratio of maximum length dimension to minimum length dimension (=maximum length/minimum length), as counted on about 60 particles from a scanning electron microscopy (SEM) image of the PEKK powder particles obtained according to the process of the invention. The dimensions of the powder particle are measured in various different directions.

According to an embodiment of the present invention, the step of grinding in the method of the present invention takes place in a disc mill in which rotating discs crush the coarse PEKK polymer by attrition forces. The disc mill used to grind the coarse PEKK powder can, for example, include a drive shaft and a pair of axially spaced cooperating milling discs mounted on each end of the drive shaft. One of the two discs can be rotatably mounted on the drive shaft and the other disc be stationary, with a fixed but adjustable gap between the discs. The disc pairs can be contained in housings having an inlet for introduction of material to be worked, and an outlet for discharge of material after working by the discs. According to an embodiment, the PEKK material to be ground enters the center of the discs and is centrifugally forced through the gap in the discs. Ground material is conveyed pneumatically to a cyclone where it can be dropped into a collection container.

The PEKK material to be ground may be passed back through the same mill or through other serially arranged mills, possibly using a sieve or an air classifying mill, until the desired material fineness is achieved. The coarse PEKK powder may therefore, for example, be passed in a single mill and a series of successive passes of the materials there through is used. Alternatively when a series of mills is used, a single pass through each mill may be employed.

The grinding process of the present invention may be continuous or semi-continuous.

According to an embodiment, the PEKK polymer to be ground or milled in the process of the present invention is such that it has a BET surface area ranging from 1 to 100 m²/g, preferably from 10 to 60 m²/g, as measured by ISO 9277, using a soak/evacuation temperature of at most 25° C.

According to an embodiment, the PEKK polymer to be ground or milled in the process of the present invention is such that it has a bulk density ρB of below 0.70, for example between 0.65 and 0.2 or between 0.6 and 0.3.

According to an embodiment, the PEKK polymer to be ground or milled in the process of the present invention is such that it has a Td (1%) of at least 500° C., preferably 505° C., more preferably 510° C., as measured by thermal gravimetric analysis according to ASTM D3850, heating from 30° C. to 800° C. under nitrogen using a heating rate of 10° C./min. A PEKK polymer having such a low volatiles content can be obtained by a nucleophilic polycondensation method.

According to an embodiment, the PEKK polymer to be ground or milled in the process of the present invention is obtained from a polycondensation reaction, in which the polycondensation of the monomers does not take place in the presence of a Lewis acid or takes place in the presence of an amount of Lewis acid of less than 2 wt. %, based on the total weight of the monomers, preferably less than 1 wt. %, more preferably less than 0.5 wt. %.

According to an embodiment, the PEKK polymer to be ground or milled in the process of the present invention is obtained from a preparation method comprising:
the preparation of a PEKK polymer by polycondensation reaction in a solvent in the absence of a Lewis acid or in the presence of an amount of Lewis acid of less than 2 wt. %, based on the total weight of the monomers, preferably less than 1 wt. %, more preferably less than 0.5 wt. %, and
the extraction of the salts and the solvent, in order to obtain a coarse PEKK powder.

In the context of the present invention, the Lewis acid may be selected from the group consisting of BF₃, AlCl₃, FeCl₃, CF₃SO₃H and CH₃SO₃H.

According to an embodiment, the PEKK polymer to be ground or milled in the process of the present invention is obtained from a preparation method comprising:

Step a) polycondensing monomers (P-OH), (M-OH), (P-F) and/or (M-F), in a solvent:

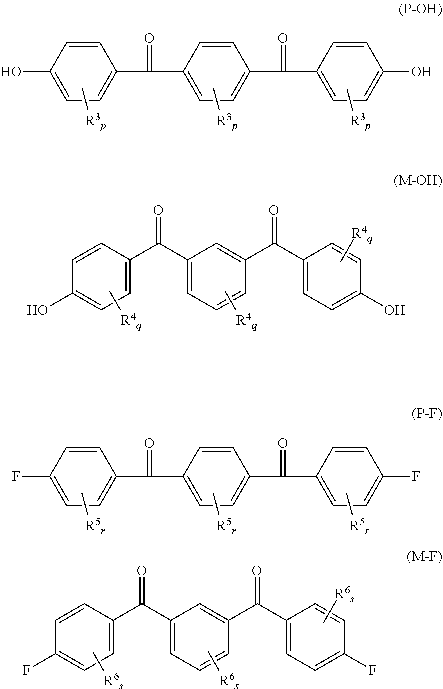

wherein
R³, R⁴, R⁵ and R⁶, at each instance, are independently selected from the group consisting of an alkyl, an alkenyl, an alkynyl, an aryl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine, and a quaternary ammonium;
p, q, r and s, at each instance, are an independently selected from 0 to 4;
   wherein the molar ratio of moles of (P-OH) and (M-OH) to moles of (P-F) and (M-F) is such that:

$$0.90 \leq \frac{{n}_{( P - OH )} + {n}_{( M - OH )}}{{n}_{( P - F )} + {n}_{( M - F )}} \leq 1.10$$

Step b) extracting the solvent and the salts, in order to obtain a coarse PEKK powder.

According to an embodiment, R³, R^{4,} R⁵ and R⁶, at each location in formula (P-OH), (P-F), (M-OH) and (M-F) above, are independently selected from the group consisting of a C1-C12 moiety optionally comprising one or more than one heteroatoms; sulfonic acid and sulfonate groups; phosphonic acid and phosphonate groups; amine and quaternary ammonium groups.

According to another embodiment, p, q, r and s are zero for each R³, R^{4,} R⁵ and R⁶ group. According to this embodiment, Step a) consists in polycondensing monomers (P′-OH), (M′-OH), (P′-F) and/or (M′-F), in a solvent:

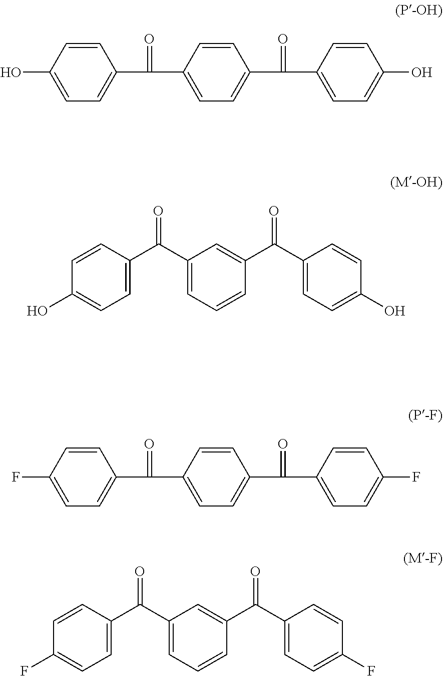 [SMILES: O=C(c1ccc(O)cc1)c1ccc(C(=O)c2ccc(O)cc2)cc1 ; O=C(c1ccc(O)cc1)c1cccc(C(=O)c2ccc(O)cc2)c1 ; O=C(c1ccc(F)cc1)c1ccc(C(=O)c2ccc(F)cc2)cc1 ; O=C(c1ccc(F)cc1)c1cccc(C(=O)c2ccc(F)cc2)c1]

According to this embodiment, the molar ratio of moles of (P-OH) and (M-OH) to moles of (P-F) and (M-F) is such that:

$$0.90 \leq \frac{{n}_{( P - OH )} + {n}_{( M - OH )}}{{n}_{( P - F )} + {n}_{( M - F )}} \leq 1.10 , \\ preferably 0.95 \leq \frac{{n}_{( P - OH )} + {n}_{( M - OH )}}{{n}_{( P - F )} + {n}_{( M - F )}} \leq 1.05 , \\ more preferably 0.98 \leq \frac{{n}_{( P - OH )} + {n}_{( M - OH )}}{{n}_{( P - F )} + {n}_{( M - F )}} \leq 1.02 , \\ even more preferably 0.985 \leq \frac{{n}_{( P - OH )} + {n}_{( M - OH )}}{{n}_{( P - F )} + {n}_{( M - F )}} \leq 1.00 .$$

According to an embodiment, the preparation of a PEKK polymer by polycondensation reaction preferably takes place in a solvent. The solvent can include, but is not limited to, diphenyl sulfone, dibenzothiophene dioxide, benzophenone or combinations of any one or more thereof. Preferably, the solvent includes diphenyl sulfone. More preferably, the solvent includes at least 90 wt. %, at least 95 wt. %, at least 98 wt. % or at least 99 wt. % diphenyl sulfone.

According to an embodiment, the preparation of a PEKK polymer by polycondensation reaction preferably takes place in the presence of at least one base, for example an alkali metal carbonate and/or alkali metal bicarbonate, more precisely sodium carbonate, potassium carbonate, sodium bicarbonate and/or potassium bicarbonate. Preferably, the base(s) used in the preparation of a PEKK polymer by polycondensation reaction are sodium carbonate and/or potassium carbonate. Most preferably, a mixture of sodium carbonate and potassium carbonate is used.

According to an embodiment, the polycondensation step may comprise at least one step consisting in heating the reaction mixture to a first temperature of from 180° C. to 320° C., for example from 185° C. to 310° C. or from 190° C. to 305° C. The polycondensation step may also comprise a second step consisting in heating the reaction mixture to a second temperature of from 300° C. to 340° C., for example from 305° C. to 335° C. or from 310° C. to 330° C.

After polycondensation, according to step b) of the PEKK preparation method, the PEKK polymer may be recovered by filtration of the salts, washing and optionally drying of the powder. Acetone and water may for example be used to extract the salts and the solvent.

The process of obtaining a powder of PEKK polymer of the present invention may comprise, in addition to the step of grinding at a temperature comprised between 60° C. and 85° C. inclusive, a further step of separation, preferably in an air separator or classifier.

The process of obtaining a powder of PEKK polymer of the present invention may comprise, in addition to the step of grinding at a temperature comprised between 60° C. and 85° C. inclusive, a further step consisting in exposing the powder to a temperature (Ta) ranging from the glass transition temperature (Tg) of the PEKK polymer and the lower melting temperature (Tm) of the PEKK polymer, both Tg and Tm being measured using differential scanning calorimetry (DSC) according to ASTM D3418. The temperature Ta can be selected to be at least 20° C. above the Tg of the PEKK polymer, for example at least 30, 40 or 50° C. above the Tg of the PEKK polymer. The temperature Ta can be selected to be at least 5° C. below the Tm of the PEKK polymer, for example at least 10, 20 or 30° C. below the Tm of the PEKK polymer. The exposition of the powder to the temperature Ta can for example be by heat-treatment and can take place in an oven (static, continuous, batch, convection), fluid bed heaters. The exposition of the powder to the temperature Ta can alternatively be by irradiation with electromagnetic or particle radiation. The heat treatment can be conducted under air or under inert atmosphere. Preferably, the heat treatment is conducted under inert atmosphere, more preferably under an atmosphere containing less than 2% oxygen. The optional step of heat treatment may take place before grinding or after grinding, but preferably takes place after the step of grinding.

PEKK Powder

The present invention also relates to a PEKK powder obtained by the grinding method of the present invention.

The powder particles of the PEKK powder after the step of grinding preferably have an aspect ratio of less than 2.0. Such aspect ratio of the powder particles is more preferably of less than 1.5, and most preferably of less than 1.48. In the context of the invention, aspect ratio is the average ratio of maximum length dimension to minimum length, as counted on about 60 particles from a scanning electron microscopy (SEM) image. The dimensions of the powder particle are measured in various different directions.

The powder particles of the PEKK powder after the step of heat treatment preferably have an aspect ratio of less than 1.5, preferably, less than 1.48.

In the present invention, the poly(ether ketone ketone) (PEKK) comprises recurring units (R_{M}) of formula (M) and recurring units (R_{P}) of formula (P), the total number of moles of recurring units (R_{M}) and (R_{P}) being at least 50 mol. % (based on the total number of moles in the polymer):

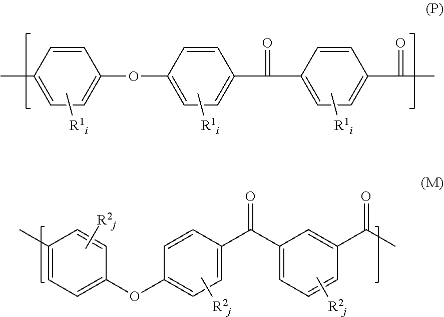

wherein
R¹ and R², at each instance, are independently selected from the group consisting of an alkyl, an alkenyl, an alkynyl, an aryl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine, and a quaternary ammonium; and
i and j, at each instance, are selected from 0 to 4. When i and/or j are zero, the recurring units (M) and/or (P) are not substituted.

According to an embodiment, R¹ and R², at each location in formula (P) and (M) above, are independently selected from the group consisting of a C1-C12 moiety optionally comprising one or more than one heteroatoms; sulfonic acid and sulfonate groups; phosphonic acid and phosphonate groups; amine and quaternary ammonium groups.

According to another embodiment, i and j are zero for each R¹ and R² group. According to this embodiment, the PEKK polymer comprises at least 50 mol. % of recurring units of formulas (M′) and (P′), the mol. % being based on the total number of moles in the polymer:

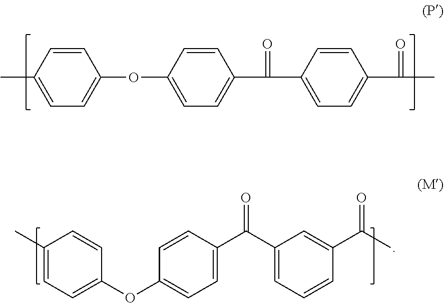

According to an embodiment of the present disclosure, at least 55 mol. %, at least 60 mol. %, at least 70 mol. %, at least 80 mol. %, at least 90 mol. %, at least 95 mol. %, at least 99 mol. % or all of the recurring units in the PEKK are recurring units of formulas (M), (M′), (P) and (P) (based on the total number of moles in the polymer).

In the PEKK polymer, the molar ratio of recurring units (P) or/and (P′) to recurring units (M) or/and (M′) may be at least 1:1, for example between 1:1 and 6:1, for example between 1.2:1 and 4:1, between 1.4:1 and 3:1 or between 1.4:1 and 1.86:1.

The PEKK of the present invention may have one or two melting temperatures, Tm (° C.). Melting temperatures are measured on the 1^{st} heat scan by differential scanning calorimetry (DSC) according to ASTM D3418. For sake of clarity, when reference is made, in the present application, to the melting temperature of the PEKK polymer, reference is in fact made to the highest Tm in case the PEKK has two Tm temperatures.

The PEKK polymer has preferably an inherent viscosity of at least 0.50 dL/g, as measured following ASTM D2857 at 30° C. on 0.5 wt./vol. % solutions in concentrated H₂SO₄ (96 wt. % minimum), for example at least 0.60 dL/g or at least 0.65 dL/g and for example at most 1.50 dL/g, at most 1.40 dL/g, or at most 1.30 dL/g.

According to the present invention, the powder has a d₅₀-value comprised between 40 μm and 60 μm, as measured by laser scattering in isopropanol, preferably between 43 μm and 57 μm, or between 45 μm and 55 μm or between 46 μm and 54 μm.

According to an embodiment of the present invention, the powder has a d₉₀-value less than 120 μm, as measured by laser scattering in isopropanol. According to an embodiment, the powder has a d₉₀-value less than 115 μm, as measured by laser scattering in isopropanol, preferably less than 110 μm or less 105 μm.

According to an embodiment of the present invention, the powder has a d₁₀-value higher than 15 μm, as measured by laser scattering in isopropanol. According to an embodiment, the powder has a d₁₀-value higher than 20 μm, as measured by laser scattering in isopropanol, preferably higher than 25 μm or higher than 28 μm.

According to an embodiment of the present invention, the powder has a d₉₉-value less than 195 μm, as measured by laser scattering in isopropanol. According to an embodiment, the powder has a d₉₉-value less than 190 μm, as measured by laser scattering in isopropanol, preferably less than 180 μm or less 170 μm.

The powder of the present invention may have a BET surface area ranging from 0.05 to 5 m²/g, preferably from 0.1 to 4 m²/g, more preferably from 0.15 to 2.0 m²/g, as measured by ISO 9277, using a soak/evacuation temperature of at most 25° C.

According to an embodiment of the present disclosure, the PEKK has a Tm ranging from 270 and 360° C., preferably from 280 and 315° C., as measured by differential scanning calorimetry (DSC) according to ASTM D3418.

According to another embodiment of the present disclosure, the PEKK has a Tg ranging from 140 and 170° C., preferably from 145 and 165° C., as measured by differential scanning calorimetry (DSC) according to ASTM D3418.

According to a preferred embodiment of the present disclosure, the powder has a bulk density ρB (or poured bulk density as described in the examples) of at least 0.39, preferably at least 0.42, most preferably at least 0.45.

Applications

The present invention also relates to the use of the PEKK powder of the present invention in various applications, for example for the manufacture of 3D objects using a laser-sintering based additive manufacturing system, or in a coating composition.

Additional components may notably be added to the ground PEKK polymer, obtained from the above-described grinding process, before its use in the end-applications. For example, the additional component may be a flow agent (F). This flow agent (F) may for example be hydrophilic. Examples of hydrophilic flow aids are inorganic pigments notably selected from the group consisting of silicas, aluminas and titanium oxide. Mention can be made of fumed silica. Fumed silicas are commercially available under the trade name Aerosil® (Evonik) and Cab-O-Sil® (Cabot).

For sake of clarity, “PEKK powder” is hereby defined as the PEKK powder obtained from the process of the present invention comprising a grinding step, while the PEKK powder to be used in final applications is hereby called “polymeric powder”.

According to one embodiment, the polymeric powder of the present invention comprises at least 50 wt. % of the PEKK powder, for example at least 60 wt. % of the PEKK powder, at least 70 wt. %, at least 80 wt. %, at least 90 wt. %, at least 95 wt. %, at least 98 wt. % or at least 99 wt. % of the PEKK powder described herein.

According to an embodiment of the present invention, the polymeric powder comprises from 0.01 to 10 wt. % of a flow agent (F), for example from 0.05 to 8 wt. %, from 0.1 to 6 wt. % or from 0.15 to 5 wt. % of at least one flow agent (F), for example of at least fumed silica.

These silicas are composed of nanometric primary particles (typically between 5 and 50 nm for fumed silicas). These primary particles are combined to form aggregates. In use as flow agent, silicas are found in various forms (elementary particles and aggregates).

The polymeric powder of the present invention may further comprise at least another polymeric material. This additional polymeric material may for example be selected from the group consisting of poly(aryl ether sulfone) (PAES) polymers, for example a poly(biphenyl ether sulfone) (PPSU) polymer and/or a polysulfone (PSU) polymer, a poly(aryl ether ketone) (PAEK) polymers, for example a poly(ether ether ketone) (PEEK) polymer.

The polymeric powder of the present invention may also comprise one or several additives (A), such as lubricants, heat stabilizers, light stabilizers, antioxidants, pigments, processing aids, dyes, fillers, nanofillers or electromagnetic absorbers. Examples of these optional additives are titanium dioxide, zinc oxide, cerium oxide, silica or zinc sulphide, glass fibers, carbon fibers.

The polymeric powder of the present invention may also comprise flame retardants, such as halogen and halogen free flame retardants.

According to one embodiment, the polymeric powder of the present invention comprises:
at least 50 wt. % of PEKK powder,
from 0.01 wt. % to 10 wt. %, from 0.05 to 8 wt. %, from 0.1 to 6 wt. % or from 0.15 to 5 wt. % of at least one flow agent (F), and
optionally at least one additive (A), for example selected from the group consisting of fillers (such as milled carbon fibers, silica beads, talc, calcium carbonates) colorants, dyes, pigments, lubricants, plasticizers, flame retardants (such as halogen and halogen free flame retardants), nucleating agents, heat stabilizers, light stabilizers, antioxidants, processing aids, fusing agents and electromagnetic absorbers, based on the total weight of the PEKK powder.

Should the disclosure of any patents, patent applications, and publications which are incorporated herein by reference conflict with the description of the present application to the extent that it may render a term unclear, the present description shall take precedence.

### EXAMPLES

Raw Materials

1,2-dichlorobenzene, terephthaloyl chloride, isophthaloyl chloride, 3,5-dichlorobenzoylchloride, aluminium chloride (AlCl₃), methanol were purchased from Sigma Aldrich.

1,4-bis(4′-PB)B: 1,4-Bis(4′-phenoxybenzoyl)benzene was prepared according to IN patent 193687 (filed on Jun. 21, 1999 and incorporated herein by reference).

1,4-bis(4′-FB)B: 1,4-bis(4′-fluorobenzoyl)benzene was prepared by Friedel-Crafts acylation of fluorobenzene according to Example 1 of U.S. Pat. No. 5,300,693 to Gilb et al. (filed Nov. 25, 1992 and incorporated herein by reference), purified by recrystallization in chlorobenzene to reach a GC purity of 99.9%.

1,4-bis(4′-HB)B and 1,4-bis(4′-HB)B: 1,4-bis(4′-hydroxybenzoyl)benzene and 1,3-bis(4′-hydroxybenzoyl)benzene were respectively produced by hydrolysis of 1,4-bis(4′-fluorobenzoyl)benzene and 1,3-bis(4′-fluorobenzoyl)benzene, respectively following the procedure described in Example 1 of U.S. Pat. No. 5,250,738 to Hackenbruch et al. (filed Feb. 24, 1992 and incorporated herein by reference) and purified by recrystallization in DMF/ethanol to reach a GC purity of 99.0%.

DPS: Diphenyl sulfone (polymer grade) was commercial obtained from Proviron (99.8% pure).

Na₂CO₃: sodium carbonate, light soda ash sold under the trade name Soda Solvay® L and commercially obtained from Solvay S.A. The sodium carbonate had a d_{0.9}<150 μm and was dried before use.

K₂CO₃: potassium carbonate (d_{0.9}<45 μm), commercially obtained from Armand Products Company (USA). The potassium carbonate was dried before use.

LiCl: Lithium chloride (anhydrous powder) commercially obtained from Acros Organics (Geel, Belgium).

PEKK Preparation

PEKK #1 (e-PEKK)

This example demonstrates the synthesis of a PEKK using a preparation process in the presence of a Lewis acid and the preparation of the fine powder therefrom.

Polycondensation

In a 200 mL 4-neck reaction flask fitted with a stirrer, a dry N2 inlet tube, a thermocouple plunging in the reaction medium, and a condenser were introduced 1000 g 1,2-dichlorobenzene and 40.63 g 1,4-B(4-PB)B. Under a sweep of dry nitrogen, 3.375 g of terephthaloyl chloride, 13.880 g of isophthaloyl chloride and 0.354 g of 3,5-dichlorobenzoyl chloride were then added to the reaction mixture. The reactor was then cooled to −5° C. and 71.88 g of aluminium chloride (AlCl₃) were added slowly while keeping the temperature below 5° C. The reaction was held at 5° C. for 10 minutes then the temperature of the mixture was increased to 90° C. at 5° C./minute. The reaction mixture was held at 90° C. for 30 minutes then cooled down to 30° C. At 30° C., 250 g of methanol were added slowly to maintain the temperature below 60° C. After the end of the addition, the reaction mixture was kept under agitation for 2 hours then cooled down to 30° C.

Filtration and Washing

The solid was then removed by filtration on a Büchner. The wet cake was rinsed on the filter with an additional 188 g of methanol. The wet cake was then reslurried in a beaker with 440 g of methanol for 2 hours. The polymer solid was filtered again on Büchner funnel and the wet cake was rinsed on the filter with 188 g of methanol. The solid was slurried with 470 g of an aqueous hydrochloric acid solution (3.5 wt %) for 2 hours. The solid was then removed by filtration on a Büchner. The wet cake was rinsed on the filter with an additional 280 g of water. The wet cake was then reslurried in a beaker with 250 g of 0.5N sodium hydroxide aqueous solution for 2 hours. The wet cake was then reslurried in a beaker with 475 g of water and filtered on Büchner funnel. The last water washing step was repeated 3 more times. The polymer reactor powder was the dried in a vacuum oven at 180° C. for 12 hours.

PEKK #2 (n-PEKK)

This example demonstrates the synthesis of a PEKK using a preparation process in which no Lewis acid is used and the preparation of the fine powder therefrom.

Polycondensation

In a 500 mL 4-neck reaction flask fitted with a stirrer, a N2 inlet tube, a Claisen adapter with a thermocouple plunging in the reaction medium, and a Dean-Stark trap with a condenser and a dry ice trap were introduced 127.82 g of DPS, 36.129 g of 1,3-bis(4′-HB)B, 9.032 g of 1,4-bis(4′-HB)B, and 46.365 g of 1,4-bis(4′-FB)B.

The flask content was evacuated under vacuum and then filled with high purity nitrogen (containing less than 10 ppm 02). The reaction mixture was then placed under a constant nitrogen purge (60 mL/min).

The reaction mixture was heated slowly to 200° C. At 200° C., 15.609 g of Na₂CO₃ and 0.098 g of K₂CO₃ was added via a powder dispenser to the reaction mixture over 60 minutes. At the end of the addition, the reaction mixture was heated to 320° C. at 1° C./minute. After 163 minutes at 320° C., 0.914 g of 1,4-Bis(4′-FB)B were added to the reaction mixture while keeping a nitrogen purge on the reactor. After 5 minutes, 0.601 g of LiCl were added to the reaction mixture. 10 minutes later, another 0.457 g of 1,4-bis(4′-FB)B were added to the reactor and the reaction mixture was kept at temperature for 15 minutes.

Extraction

The reactor content was then poured from the reactor into a SS pan and cooled. The solid was broken up and ground in an attrition mill through a 2 mm screen. Diphenyl sulfone and salts were extracted from the mixture with acetone and water at pH between 1 and 12. The powder was then removed from the reactor and dried at 120° C. under vacuum for 12 hours yielding 81 g of an off-white/yellow powder. The polymer has a T/I ratio of 60/40. The powder presents a d_{0.9}-value of 1425 μm and d_{0.5}-value of 650 μm.

Characterization of the Coarse PEKK Powders

Thermal Decomposition Temperatures (Td)

The thermal decomposition temperature at 1 wt. % loss, Td (1%), was measured by thermal gravimetric analysis (“TGA”) according to the ASTM D3850. TGA was performed on a TA Instruments TGA Q500 from 30° C. to 800° C. under nitrogen (60 mL/min) at a heating rate of 10° C./minute.

Thermal Transitions (Tg, Tm)

The glass transition and melting temperatures of the polymers were measured using differential scanning calorimetry (DSC) according to ASTM D3418 employing a heating and cooling rate of 10° C./min. Three scans were used for each DSC test: a first heat up to 360° C., followed by a first cool down to 30° C., followed by a second heat up to 360° C. The Tg and the Tm were determined from the second heat up. DSC was performed on a TA Instruments DSC Q20 with nitrogen as carrier gas (99.998% purity, 50 mL/min).

Melt Flow Index (MFI)

MFI was measured using ASTM D1238 at 340° C. with a 8.4 kg weight with a 6 minute-dwell time.

Inherent Viscosity (IV)

IV was measured following ASTM D2857 at 30° C. on 0.5 wt./vol. % solutions in concentrated H₂SO₄ (96 wt. % minimum) using a Cannon-Fenske capillary, size 200.

TABLE 1
results

| | PEKK#1 | PEKK#2 |
|---|---|---|
| Td(1%) (° C.) | 461.1 | 521.04 |
| Tm (° C.) | 282 | 312 |
| Tg (° C.) | 152 | 159 |
| IV (dL/g) | 1.07 | 0.87 |
| MFI (g/10 min) | 33 | 43 |

Grinding Tests

Several methods were used as described below, with the purpose of obtaining the following PSD specification:
d₁₀-value higher than 15 μm
a d₉₀-value of less than 120 μm
a d₅₀-value comprised between 40 and 60 μm

Characterization of the PEKK Powder

PSD (d₁₀, d₅₀, d₉₀)

The PSD (volume distribution) was determined by an average of 3 runs using laser scattering Microtrac S3500 analyzer in wet mode (128 channels, between 0.0215 and 1408 μm). The solvent was isopropanol with a refractive index of 1.38 and the particles were assumed to have a refractive index of 1.59. The ultrasonic mode was enabled (25 W/60 seconds) and the flow was set at 55%.

BET Surface Area

The porosity of the powders was measured according to ISO9277 using a soak/evacuation temperature of 25° C.

Poured Bulk Density (ρB)

Bulk density was determined by adding ground polymer to a tared 100 mL graduated cylinder to about 90-95 mL and allowing the material to settle naturally. The volume was read and the cylinder reweighed. The bulk density was determined by the following formula:

ρB=mass/volume

Aspect Ratio (AR)

The term aspect ratio was measure on at least 60 particles from a scanning electron microscopy (SEM) image of the PEKK powder particle. The dimensions of the powder particle were measured in various different directions. The aspect ratio value represents the average ratio of maximum length dimension to minimum length dimension (=maximum length/minimum length).

Grinding Test #1

The two PEKK were first processed on an attrition mill (Retsch). The temperature measured in the grinder was less than 40° C.

This processing was successful with PEKK #1 and yielded to a significant particle size reduction. However this was unsuccessful with PEKK #2 and yielded to no significant particle size reduction.

TABLE 2
results:

| | PEKK#1 | PEKK#2 |
|---|---|---|
| d50-value (μm) | 48.1 | 65.3 |
| Aspect ratio | Above 1.5 | nd |

Grinding Tests #2

Grinding test #2a: Micro-jet mill (Fluid Energy)

PEKK #2 was first processed on an 8-inch MICRO-JET mill (Fluid Energy).

This processing was unsuccessful with PEKK #2 and yielded to no significant particle size reduction.

Grinding Test #2b: Roto-Jet Mill (Fluid Energy) at Room Temperature

PEKK #2 was then processed in a Roto-Jet system (Fluid Energy).

Initially this seemed to yield a d₅₀-value of 61 μm; however, after further processing the Roto-Jet merely classified the powder present in the raw feed. This was discovered due to a small yield of powder. Upon opening the mill, the raw feed contained in the bed was discovered to be unground.

Grinding Test #2c: Roto-Jet Mill (Fluid Energy) with Precooling of the Materials

Even when the material was precooled, this showed no increase in grindability.

Grinding Test #2d: Disc-Mill Below 45° C. (about 40° C.)

PEKK #2 was then processed in a disc-mill (Wedco Therm-O-Fine Mill System, Model SE-12-C). The temperature measured at the exit of the grinding discs was less than 45° C. (about 40° C.).

The grinding equipment consists of a radially grooved set of discs, one stationary, one rotating with a gap of 0.1 mm.

Grinding Test #2e: Disc-Mill at 72-74° C.

The same equipment was used than the one used for test #2d, except that the grinding parameters were adjusted in order for the temperature in the grinder to be at 72-74° C. The ground powder was the heat treated as follows: 2.5-hour ramp from room temperature to 268° C. then hold for 1.5 hour at 268° C. (temperature measured in the oven).

TABLE 3
results:

| | PEKK#2 |
|---|---|
| d₁₀-value (μm) | 35.9 |
| d₅₀-value (μm) | 57.0 |
| d₉₀-value (μm) | 92.3 |
| d₉₉-value (μm) | 172.3 |
| BET (m²/g) | 0.20 |
| Bulk density | 0.53 |
| Aspect ratio | 1.46 |

1-15. (canceled)

16. A process of obtaining a powder of poly(ether ketone ketone) (PEKK) polymer having a d₅₀-value comprised between 40 μm and 60 μm (as measured by laser scattering in isopropanol), comprising grinding a PEKK polymer at a temperature comprised between 60° C. and 85° C.,
wherein the PEKK polymer comprises recurring units (R_{P}) of formula (P) and recurring units (R_{M}) of formula (M), the total number of moles of recurring units (R_{P}) and (R_{M}) in the polymer being at least 50 mol. %, based on the total number of moles in the polymer: 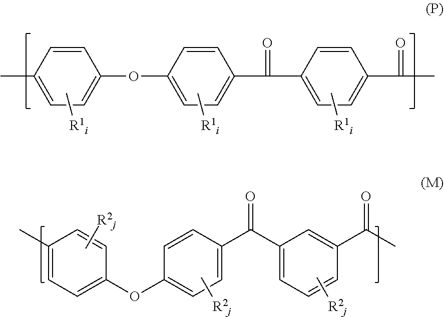
wherein
R¹ and R², at each instance, are independently selected from the group consisting of an alkyl, an alkenyl, an alkynyl, an aryl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine, and a quaternary ammonium; and
i and j, at each instance, are independently selected from 0 to 4.

17. The process of claim 1, wherein the PEKK polymer has a Td (1%) of at least 500° C., as measured by thermal gravimetric analysis according to ASTM D3850, heating from 30° C. to 800° C. under nitrogen using a heating rate of 10° C./min.

18. The process of claim 16, wherein the powder has a d₁₀-value higher than 15 μm and/or a d₉₀-value of less than 120 μm, as measured by laser scattering in isopropanol.

19. The process of claim 16, wherein the PEKK polymer has been obtained by a preparation method comprising:
Step a/ preparing the PEKK polymer by polycondensation reaction in a solvent in the absence of a Lewis acid or in the presence of an amount of Lewis acid of less than 2 wt. %, based on the total weight of the monomers,
Step b/ extracting the salts and the solvent, in order to obtain a coarse PEKK powder,
Step c/ grinding.

20. The process of claim 16, comprising an additional step consisting in exposing the powder to a temperature (Ta) ranging from the glass transition temperature (Tg) of the PEKK polymer and the lower melting temperature (Tm) of the PEKK polymer, both Tg and Tm being measured using differential scanning calorimetry (DSC) according to ASTM D3418.

21. The process of claim 16, wherein the molar ratio of recurring units (P) to recurring units (M) in the PEKK polymer ranges between 1:1 and 6:1.

22. The process of claim 16, wherein the PEKK polymer comprises recurring units (R_{P}) of formula (P′) and recurring units (R_{M}) of formula (M′):

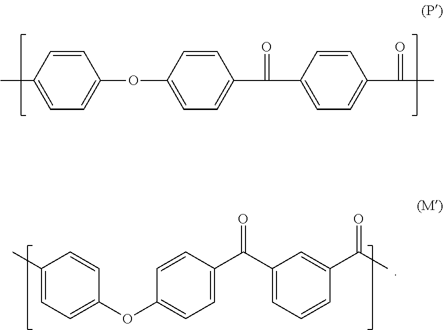

23. The process of claim 16, wherein the powder of PEKK has after the step of grinding:
a BET surface area ranging from 0.1 to 5 m²/g, as measured by ISO 9277, at a soak temperature of 25° C.,
a bulk density ρB of at least 0.39, and/or
an aspect ratio AR of less than 1.5, wherein the aspect ratio is the average ratio of maximum length dimension to minimum length, as counted on about 100 particles from a scanning electron microscopy (SEM) image.

24. The process of claim 16, wherein the step of grinding takes place in a disc mill in which rotating discs crush the PEKK polymer by attrition forces.

25. A PEKK powder obtained by the process of claim 16.

26. A PEKK powder having a d₅₀-value comprised between 40 μm and 60 μm, as measured by laser scattering in isopropanol, and an aspect ratio AR of less than 1.5, wherein the aspect ratio is the average ratio of maximum length dimension to minimum length, as counted on about 60 particles from a scanning electron microscopy (SEM) image.

27. The PEKK powder of claim 25, having:
a BET surface area ranging from 0.1 to 5 m²/g, as measured by ISO 9277, at a soak temperature of 25° C., and/or
a bulk density ρB of at least 0.39.

28. A polymeric powder comprising:
the PEKK powder of claim 25,
at least one flow agent (F), and/or
at least one additive (A) selected from the group consisting of fillers, colorants, dyes, pigments, lubricants, plasticizers, flame retardants, nucleating agents, heat stabilizers, light stabilizers, antioxidants, processing aids, fusing agents and electromagnetic absorbers.

29. A method of manufacturing a three-dimensional object, the method comprising laser-sintering the PEKK powder of claim 25.

30. A coating composition comprising the PEKK powder of claim 25.
